(19) United States
(12) Patent Application Publication
(10) Pub. No.: US 2022/0067582 A1
(43) Pub. Date: Mar. 3, 2022

(54) METHOD AND APPARATUS FOR CONTINUAL FEW-SHOT LEARNING WITHOUT FORGETTING

(71) Applicant: Samsung Electronics Co., Ltd., Gyeonggi-do (KR)

(72) Inventors: Yoo Jin CHOI, San Diego, CA (US); Mostafa El-Khamy, San Diego, CA (US); Sijia Wang, Durham, NC (US); Jungwon Lee, San Diego, CA (US)

(73) Assignee: Samsung Electronics Co. Ltd.

(21) Appl. No.: 17/156,126

(22) Filed: Jan. 22, 2021

Related U.S. Application Data
(60) Provisional application No. 63/071,067, filed on Aug. 27, 2020.

(51) Int. Cl. G06N 20/00; G06K 9/62

(52) U.S. Cl. CPC G06N 20/00; G06K 9/628

(57) ABSTRACT

Methods and apparatuses are provided for continual few-shot learning. A model for a base task is generated with base classification weights for base classes of the base task. A series of novel tasks is sequentially received. Upon receiving each novel task in the series of novel tasks, the model is updated with novel classification weights for novel classes of the respective novel task. The novel classification weights are generated by a weight generator based on one or more of the base classification weights and, when one or more other novel tasks in the series are previously received, one or more other novel classification weights for novel classes of the one or more other novel tasks. Additionally, for each novel task, a first set of samples of the respective novel task are classified into the novel classes using the updated model.

### PRIORITY

This application is based on and claims priority under 35 U.S.C. § 119(e) to a U.S. Provisional Patent application filed on Aug. 27, 2020 in the United States Patent and Trademark Office (USPTO) and assigned Ser. No. 63/071,067, the contents of which are incorporated herein by reference.

### FIELD

The present disclosure relates generally to machine learning methods, and more particularly, to a method and an apparatus for continual few-shot learning.

### BACKGROUND

Within the field of machine learning, it may be difficult to accrue enough data to increase the accuracy of models. In limited-data scenarios, few-shot learning algorithms have been employed to discover patterns in data and make inferences. This technique is commonly utilized in the field of computer vision, where photos are categorized or classified.

In a few-shot learning task, where N is the number of classes and K is the number of samples (or images) in each class, a small training set D is provided. The size of a training set is |D|=N·K.

A base training set D₀ may be utilized to learn transferable knowledge for improved few-shot learning. Base training set D₀ contains a large number of labeled samples from a large number of classes. However, the classes in base training set D₀ are not identical to the classes in training set D. Accordingly, traditional few-shot learning trains a model with a small amount of training data or samples, without utilizing the base classes.

An episode refers to a training and testing pair of one few-shot learning task. FIG. 1 is a diagram illustrating an episodic few-shot learning method. A first training task 102, a second training task 104, and a first test task 106 each include a respective support set 108, 110, and 112, having three classes (N=3) and two samples (images) per class (K=2). The first training task 102, the second training task 104, and the first test task 106 each also include and a respective query set 114, 116, and 118, having three samples (images). The classes differ in each of the first training task, the second training task, and the first test task.

Both metric-based and gradient-based training algorithms have been developed on top of the episodic learning framework. For example, self-supervision loss may be added to a feature extractor training procedure to enable robust semantic feature learning and to improve few-shot classification. Additionally, a Wasserstein-based method may be added to better align the distribution of features with that of considered classes. However, as described above, traditional few-shot learning does not take into account the base classes used in training.

Few-shot learning without forgetting base classes has been developed to classify novel classes when only a few labeled samples are provided for the novel classes, while also preserving the capability to classify base classes upon which the feature embedding network is trained. For example, the feature embedding network and classification weights for base classes are pre-trained by regular supervised learning and are fixed afterwards.

FIG. 2 is a diagram illustrating few-shot learning without forgetting base classes, which focuses on generating the classification weights for novel classes. A sample or test image 202 is provided to a feature extractor 204, which outputs features of the sample to a classifier 206. The classifier 206 obtains base classification weights 208 from training data for base classes 210. A few-shot classification weight generator 212 generates novel classification weights 214 for the limited training data of a novel category 216, and provides the novel classification weights 214 to the classifier 206.

More specifically, with respect to the few-shot classification weight generator 212, a weight imprinting method computes prototypes of novel classes from a pre-trained feature embedding network and uses them as the classification weights for novel classes. Also, generation of classification weights 214 for novel classes is learned by a weight generator that takes novel class prototypes 216 and the classification weights 208 for base classes as inputs, utilizing an attention-based mechanism to exploit the relation between base classes and novel classes in the generation of novel classification weights 214.

Based on the base classification weights 208 and novel classification weights 214, the classifier outputs a probability of base and novel classes for the sample 202.

Further, the novel classification weights may be trained by a gradient-based optimization process using the cross-entropy loss from a few labeled samples of the novel classes until they converge. Since the loss for training novel classification weights is computed only with the samples of the novel classes, a forgetting issue for base classes may arise. To prevent this, an attention-based regularization method is applied. The regularization loss is provided by an attention attractor network. The attention attractor network generates attractor vectors using the base classification weights, and the regularization loss is computed based on the Mahalanobis distances between the novel classification weights and attractor vectors.

### SUMMARY

According to one embodiment, a method is provided for continual few-shot learning. A model for a base task is generated with base classification weights for base classes of the base task. A series of novel tasks is sequentially received. Upon receiving each novel task in the series of novel tasks, the model is updated by a weight generator with novel classification weights for novel classes of the respective novel task. The novel classification weights are generated based on one or more of the base classification weights and, when one or more other novel tasks in the series are previously received, one or more other novel classification weights for novel classes of the one or more other novel tasks. Additionally, for each novel task, a first set of samples of the respective novel task are classified into the novel classes using the updated model.

According to one embodiment, a UE is provided that includes a processor and a non-transitory computer readable storage medium storing instructions. When executed, the instructions cause the processor to generate a model for a base task with base classification weights for base classes of the base task, and to sequentially receive a series of novel tasks. The instructions also cause the processor to, upon receiving each novel task in the series of novel tasks, update the model with novel classification weights for the novel classes of the respective novel task. The novel classification weights are generated by a weight generator based on one or more of the base classification weights and, when one or more other novel tasks in the series are previously received, one or more other novel classification weights for novel classes of the one or more other novel tasks. The instructions further cause the processor to, upon receiving each novel task, classify a first set of samples of the respective novel task into the novel classes using the updated model.

### BRIEF DESCRIPTION OF THE DRAWINGS

The above and other aspects, features, and advantages of certain embodiments of the present disclosure will be more apparent from the following detailed description, when taken in conjunction with the accompanying drawings, in which:

FIG. 1 is a diagram illustrating episodic few-shot learning;

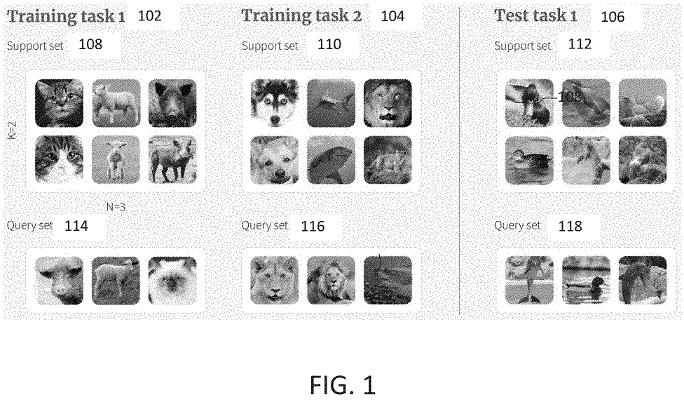

FIG. 2 is a diagram illustrating few-shot learning without forgetting base classes;

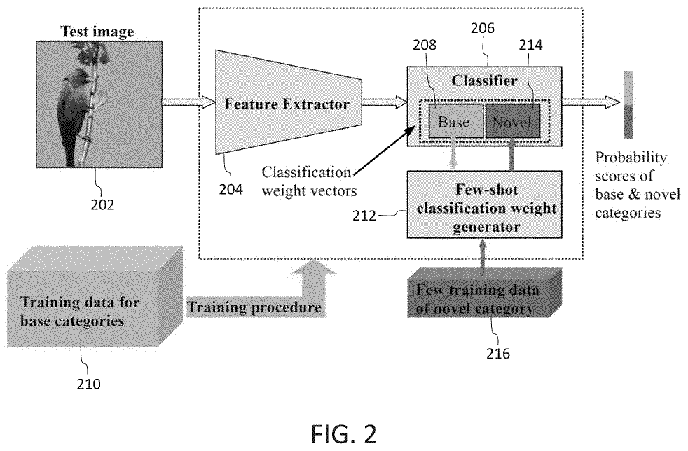

FIG. 3 is a is a diagram illustrating an example of continual few-shot learning in three stages, according to an embodiment;

FIG. 4 is a flowchart illustrating a method for continual few-shot learning, according to an embodiment; and

FIG. 5 is a block diagram of an electronic device in a network environment, according to an embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate the existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device according to one embodiment may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, or firmware, and may interchangeably be used with other terms, such as, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

Embodiments of the disclosure provide a framework for continual few-shot learning. Such a framework can be used in many applications to progressively learn new tasks (e.g., new classes, new objects, etc.), without forgetting the older tasks that have already been learned.

A model for a base task (having base classes) is pre-trained. The model for novel tasks (having novel classes) is then updated. For the novel tasks, it is assumed that only a few samples (e.g., 1 sample or 5 samples) are provided for each novel class, as in traditional few-shot learning. A base task T₀ is provided given base training set D₀. A series of N-way K-shot few shot learning tasks Tᵢ are sequentially learned, given training sets Dᵢ for i=1, 2, . . . .

The number of few-shot learning tasks is indefinite. Training set Dᵢ is from a set of classes Cᵢ such that Cᵢ∩Cⱼ=ϕ, ∀i≠j.

For each task Tᵢ, a model is updated with the only the current training set Dᵢ. Data from past tasks cannot be revisited. However, in testing, the trained model is evaluated on all previous classes (i.e., C₀∪C₁∪ . . . ∪Cᵢ).

Continual few-shot learning has a more practical usage than traditional few-shot learning in that the model remembers all learned classes when training data progressively arrives.

A more detailed description of the above-described continual few-shot learning steps is set forth below.

First, a feature extractor F_{θ} and a set of classification weight vectors W₀=[w_{c}]_{c∈C}_{₀} are pre-trained. For example, assuming linear classification after feature extraction, the inference (or testing) output y for input x is given by Equation (1) below:

$$\hat{y} = {argmax}_{c ∈ {C}_{0}} \{ {w}_{c}^{T} {F}_{θ} ( x ) \} \qquad ( 1 )$$

After learning task Tᵢ, inference is performed as set forth in Equation (2) below:

$$\hat{y} = {argmax}_{c ∈ {C}_{0} ⋃ {C}_{1} ⋃ … ⋃ {C}_{i}} \{ {w}_{c}^{T} {F}_{θ} ( x ) \} \qquad ( 2 )$$

All classes learned are of interest, and a set of classification weight vectors Wᵢ=[w_{c}]_{c∈C}_{₀} for the novel classes Cᵢ of task Tᵢ are needed, given W₀, W₁, . . . , Wᵢ₋₁.

In order to obtain the set of classification weight vectors Wᵢ for the novel classes Cᵢ, a weight generator utilizes the few-shot training set Dᵢ and the classification weights for the previously learned classes (i.e., W₀, W₁, . . . , Wᵢ₋₁). Specifically, where g_{ϕ} denotes the weight generator, and using the feature extractor output of the few-shot training set Dᵢ, Wᵢ is set forth in Equation (3) below:

Wᵢ=g_{ϕ}(F_{θ}(Dᵢ),W₀,W₁, . . . ,Wᵢ₋₁) (3)

Thus, in continual few-shot learning, the weight generator uses all previously learned classification weights as its input, as a series of few-shot tasks are progressively learned, to produce the classification weights for the novel class, rather than only using the base class weights, as in few-shot learning without forgetting base classes.

As the number of learned few-shot tasks increases, the number of classification weights that are provided to the above-described weight generator grows. Accordingly, two methods are provided for training the weight generator.

In a first method, the weight generator is optimized for a random number of new base classes. First, “fake” few-shot learning tasks are constructed from D₀. Specifically, the number of new base classes Ĉ₀ is randomly selected (i.e., N₀^{min}≤|Ĉ₀|≤|C₀|). “New” base classes Ĉ₀ and “fake” novel classes Ĉ₁ are randomly selected from the base classes C₀ (i.e., Ĉ₀∩Ĉ₁=ϕ, |Ĉ₁|=N). K samples are randomly selected for each class of Ĉ₁ and put in Ŝ₁. The K samples are fed to the weight generator. Some samples are randomly selected for each class from Ĉ₀ and Ĉ₁, and put in \hat{D}₀ and \hat{D}₁, respectively. The randomly selected samples are used to calculate cross-entropy.

Optimization is performed in accordance with Equation (4) below:

$${min}_{{W}_{0} , ϕ} E [ {E}_{x , y ∈ {\hat{D}}_{0} ⋃ {\hat{D}}_{1}} [ CrossEntropy ( y , softmax ( {[ {\hat{W}}_{0} , {g}_{ϕ} ( {\hat{S}}_{1} , {\hat{W}}_{0} ) ]}^{T} {F}_{θ} ( x ) ) ) ] ] \qquad ( 4 )$$

where Ŵ₀ are the classification weight vectors in W₀ that correspond to Ĉ₀.

In another embodiment, multiple weight generators are trained for random numbers of “new” base classes. Assuming that the number of base classes belongs to a fixed finite range (e.g., 50 to 100), a separate weight generate is trained for each random number of base classes. The weights of multiple weight generators are averaged to get one fused weight generator.

When the number of few-shot learning tasks that are added after the base model is arbitrary and is not pre-determined, it is difficult to optimize the weight generator for an arbitrary number of few-shot learning tasks. In a second method for training the weight generator, the number of few-shot learning tasks are limited (e.g., three) and the weight generator is trained to minimize the classification error over the fixed number of few-shot leaning tasks.

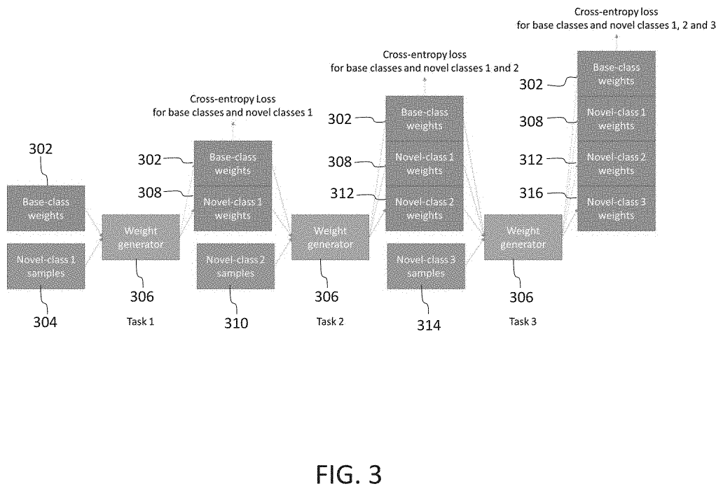

FIG. 3 is a diagram illustrating an example of continual few-shot learning in three stages, according to an embodiment. In a first stage, a model is trained for the base classes. Using base class weights 302 and a first set of novel class samples 304, a weight generator 306 generates a first set of novel classification weights 308 for the first few-shot task. In a second stage, the classification weights for the base classes 302 and the generated first set of classification weights 308 are used by the weight generator 306 in combination with a second set of novel class samples 310 to generate a second set of classification weights 312 for the second few-shot learning task. In a third phase, the classifications weights for the base classes 302, the generated first set of classification weights 308, and the generated second set of classification weights 312 are used by the weight generator 306 in combination with a third set of novel class samples 314 to generate a third set of classification weights 316 for the third few-shot learning task.

This continual few-shot learning is performed a fixed number of times. In each stage, the loss that is used to train the weight generator is defined as the cross-entropy loss for base classes and learned novel classes. The average classification loss for all stages is determined and the weight generator is optimized to minimize the average loss.

Specifically, with respect to the optimization of a weight generator for a fixed number of few-shot learning tasks, a number k of “fake” few-shot learning tasks are first constructed from D₀. Specifically, “new” base classes Ĉ₀ and k sets of “fake novel classes Ĉ₁, Ĉ₂, . . . Ĉₖ are randomly selected from the base classes C₀, as set forth in Equation (5) below:

|Ĉᵢ|=N, 1≤i≤k, |Ĉ₀|=|C₀|−kN, C₀=∪ᵢ₌₀^{k}Ĉᵢ,Ĉᵢ∩Ĉⱼ=ϕ,∀i≠j (5)

K samples are randomly selected for each class of Ĉᵢ of and put into Ŝᵢ for 1≤i≤k, respectively. The randomly selected K samples are fed to the weight generator. Some samples for each class are randomly selected from Ĉᵢ, and put into \hat{D}ᵢ for 0≤i≤k, respectively. These randomly selected samples are used to calculate cross-entropy.

Optimization is performed in accordance with Equation (6) below:

$${min}_{{W}_{0} , ϕ} {\sum }_{i = 1}^{k} E [ {E}_{x , y ∈ {\hat{D}}_{0} ⋃ {\hat{D}}_{1} ⋃ … ⋃ {\hat{D}}_{i} /} [ CrossEntrophy ( y , softmax ( {[ {\hat{W}}_{0} , {\hat{W}}_{1} , … , {\hat{W}}_{i} ]}^{T} {F}_{θ} ( x ) ) ) ] ] \qquad ( 6 )$$

where Wᵢ=g_{ϕ}(Sᵢ, W₀, W₁, . . . , Wᵢ₋₁) and Ŵ₀ are the classification weight vectors in W₀ that correspond to Ĉ₀.

A first architecture for a weight generator includes a bi-attention weight generator. Dᵢ^{c} is set as the data of class c in Dᵢ. When W₀ⁱ⁻¹=[W₀, W₁, . . . , Wᵢ₋₁], the classification weight w_{c} of class c yielded by the bi-attention weight generator is set forth in Equation (7) below:

$${w}_{c} = {mean}_{x ∈ {D}_{i}^{c}} ( {W}_{V} {W}_{0}^{i - 1} {Att ( {W}_{Q} {F}_{θ} ( x ) , {W}_{K} {W}_{0}^{i - 1} )}^{T} ) \qquad ( 7 )$$

where W_{Q}, W_{K}, and W_{V} are linear transformation weights for query, key, and value of the bi-attention module, and

$$Att ( A , B ) = softmax ( \frac{{A}^{T} B}{\sqrt{d}} )$$

A second architecture for a weight generator includes a self-attention weight generator, in which

$${W}_{all} = [ {W}_{0}^{i - 1} , {mean}_{x ∈ {D}_{i}^{{c}_{1}}} ( {F}_{θ} ( x ) ) , … , {mean}_{x ∈ {D}_{i}^{{c}_{N}}} ( {F}_{θ} ( x ) ) ] ,$$

for c₁, . . . , c_{N}∈Cᵢ. The classification weight yielded by the self-attention weight generator is set forth in Equation (8) below:

Wₐₗₗ→W_{V}WₐₗₗAtt(W_{Q}Wₐₗₗ,W_{K}Wₐₗₗ)^{T} (8)

where N_{B} is the number of base classes and Xₙ denotes the n-th column of X.

The self-attention weight generator differs from the bi-attention weight generator in that the base-class weights are updated in the self-attention weight generator.

The proposed weight generator modifications can be applied for the attention attractor network, having output that is used to regularize the weights (instead of generating the weights).

The bi-attention and self-attention weight generators can be modified to be a multi-head bi-attention weight generator and a multi-head self-attention weight generator, respectively.

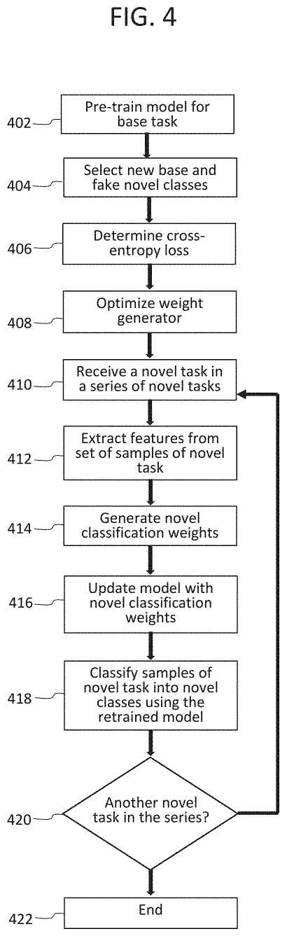

Referring now to FIG. 4, a flowchart illustrates a method for continual few-shot learning, according to an embodiment. A model for a base task is pre-trained with base classification weights for base classes of the base task, at 402. The model includes a feature extractor. New base classes and fake novel classes are selected from the base classes, at 404. An average cross-entropy loss is determined using randomly selected samples from each of the classes that are to be used to optimize a weight generator, at 406. The weight generator is optimized, at 408, using a random number of the new base classes and a fake novel task of the fake novel classes, or using a fixed number of fake novel tasks of the fake novel classes.

A novel task in a series of novel tasks is received, at 410. Features are extracted from a set of samples of the novel task, at 412. The set of samples are pre-classified into novel classes, which are different from the base classes.

Novel classification weights for the novel classes are generated, at 414. For example, the novel classification weights may be generated, by the weight generator, using the extracted features, the base classification weights, and one or more other novel classification weights. The one or more other novel classifications weights are for novel classes of one or more other novel tasks in the series that are previously received. A number of the one or more other novel tasks may be less than or equal to three.

As another example, the novel classification weights may be generated, by the weight generator, using the extracted features and classification weights of classes selected from the base classes and the novel classes of the one or more other novel tasks in the series that are previously received. For each novel task, a random number of classes may be selected for the classification weights in generating the novel classification weights.

The model is updated with the novel classification weights for the novel classes of the novel task, at 416.

A set of unclassified samples of the novel task are classified into the novel classes using the updated model, at 418. At 420 is determined whether another novel task in the series of novel tasks is to be received. When another novel task is to be received, the methodology returns to 410. When another novel task is not to be received, the methodology terminates at 422.

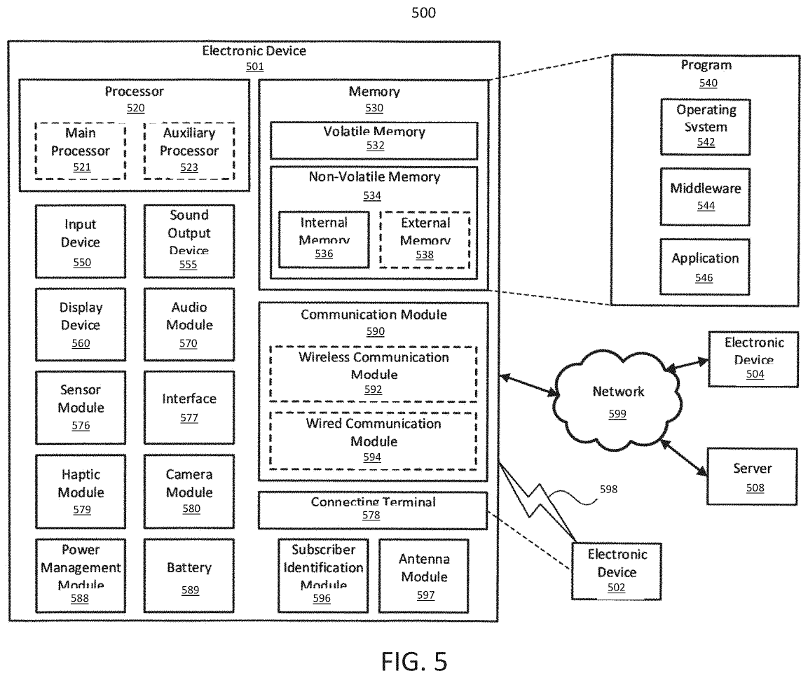

FIG. 5 is a block diagram of an electronic device in a network environment, according to one embodiment. Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute, for example, software (e.g., a program 540) to control at least one other component (e.g., a hardware or a software component) of the electronic device 501 coupled with the processor 520, and may perform various data processing or computations. As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550, or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes.

The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as Bluetooth™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

One embodiment may be implemented as software (e.g., the program 540) including one or more instructions that are stored in a storage medium (e.g., internal memory 536 or external memory 538) that is readable by a machine (e.g., the electronic device 501). For example, a processor of the electronic device 501 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method for continual few-shot learning, comprising:
generating a model for a base task with base classification weights for base classes of the base task;
sequentially receiving a series of novel tasks; and
upon receiving each novel task in the series of novel tasks:
updating the model with novel classification weights for novel classes of the respective novel task, wherein the novel classification weights are generated by a weight generator based on one or more of the base classification weights and, when one or more other novel tasks in the series are previously received, one or more other novel classification weights for novel classes of the one or more other novel tasks; and
classifying a first set of samples of the respective novel task into the novel classes using the updated model.

2. The method of claim 1, further comprising training the weight generator using a random number of the base classes and a fake novel task of fake novel classes selected from the base classes, or using a fixed number of fake novel tasks of the fake novel classes selected from the base classes.

3. The method of claim 2, wherein training the weight generator comprises determining an average cross-entropy loss using randomly selected samples from classes used to train the weight generator.

4. The method of claim 1, wherein the model comprises a feature extractor.

5. The method of claim 1, wherein each novel task further comprises a second set of samples that are classified into novel classes.

6. The method of claim 5, wherein updating the model comprises:
extracting features from the second set of samples of the respective novel task; and
generating the novel classification weights by the weight generator using the extracted features, the base classification weights, and the other novel classification weights.

7. The method of claim 6, wherein a number of the one or more other novel tasks is less than or equal to three.

8. The method of claim 5, wherein updating the model comprises:
extracting features from the second set of samples of the respective novel task; and
generating the novel classification weights by the weight generator using the extracted features and classification weights of classes selected from the base classes and the novel classes of the one or more other novel tasks.

9. The method of claim 8, wherein, for each novel task, a random number of the classes is selected for the classification weights that are used to generate the novel classification weights.

10. The method of claim 1, wherein the weight generator is a bi-attention weight generator or a self-attention weight generator.

11. A user equipment (UE) comprising:
a processor; and
a non-transitory computer readable storage medium storing instructions that, when executed, cause the processor to:
generate a model for a base task with base classification weights for base classes of the base task;
sequentially receive a series of novel tasks; and
upon receiving each novel task in the series of novel tasks:
update the model with novel classification weights for novel classes of the respective novel task, wherein the novel classification weights are generated by a weight generator based on one or more of the base classification weights and, when one or more other novel tasks in the series are previously received, one or more other novel classification weights for novel classes of the one or more other novel tasks; and
classify a first set of samples of the respective novel task into the novel classes using the updated model.

12. The UE of claim 11, wherein the processor is further configured to train the weight generator using a random number of the base classes and a fake novel task of fake novel classes selected from the base classes, or using a fixed number of fake novel tasks of fake novel classes selected from the base classes.

13. The UE of claim 12, wherein, in training the weight generator, the processor is further configured to determine an average cross-entropy loss using randomly selected samples from classes used to train the weight generator.

14. The UE of claim 11, wherein the model comprises a feature extractor.

15. The UE of claim 11, wherein each received novel task further comprises a second set of samples that are classified into novel classes.

16. The UE of claim 15, wherein, in updating the model, the processor is further configured to:
extract features from the second set of samples of the respective novel task; and
generate the novel classification weights by the weight generator using the extracted features, the base classification weights, and the other novel classification weights.

17. The UE of claim 16, wherein a number of the one or more other novel tasks is less than or equal to three.

18. The UE of claim 15, wherein, in updating the model, the processor is further configured to:
extract features from the second set of samples of the respective novel task; and
generate the novel classification weights by the weight generator using the extracted features and classification weights of classes selected from the base classes and the novel classes of the one or more other novel tasks.

19. The UE of claim 18, wherein, for each novel task, a random number of the classes is selected for the classification weights that are used to generate the novel classification weights.

20. The UE of claim 11, wherein the weight generator is a bi-attention weight generator or a self-attention weight generator.
